(19) United States
(12) Patent Application Publication
(10) Pub. No.: US 2006/0146409 A1
(43) Pub. Date: Jul. 6, 2006

(54) Multi-section laser with photonic crystal mirrors

(75) Inventors: Dan Andreyevitch Yanson, Glasgow (GB); Christopher James McBride Smith, Glasgow (GB); John Haig Marsh, Glasgow (GB)

Correspondence Address: DASPIN & AUMENT, LLP, 210 WEST 22ND STREET, SUITE 102, OAK BROOK, IL, 60523, US

(73) Assignee: Intense Photonics Limited, Glasgow (GB)

(21) Appl. No.: 10/524,684

(22) PCT Filed: Jul. 18, 2003
(86) PCT No.: PCT/GB03/03228

§ 371 Date: Feb. 15, 2006

(30) Foreign Application Priority Data
Aug. 9, 2002 (GB) 0218548.6

(51) Int. Cl. G02B 5/08

(52) U.S. Cl. 359/566; 359/843

(57) ABSTRACT

Photonic crystal material is used to couple two or more cavities of an optical device to provide tuneable laser output. The monolithically integrated optical device includes: a first optical cavity having a first optical axis and supporting first optical modes; a second optical cavity having a second optical axis and second, different, optical modes than the first optical cavity, the first and second optical cavities being laterally offset from one another and at least partially separated by a photonic crystal material in which the dielectric function of the material exhibits a periodic variation as a function of linear distance through the material, such that optical coupling between the first and second cavities is achieved through the photonic crystal. Multiple cavities can also be integrated in a similar fashion.

The present invention relates to semiconductor lasers, and particular to the use of photonic bandgap materials or “photonic crystals” in the fabrication thereof.

Photonic crystals are materials in which the dielectric function of the material exhibits a periodic variation as a function of linear distance through the material, in one or more spatial dimensions. Such materials exhibit the property of excluding photons of certain frequency ranges from existing within the crystal.

In contrast to diffraction gratings, photonic crystals may have periodicity in more than one dimension and generally employ a much larger variation of the dielectric function, which results in much stronger photon selection properties achievable with smaller crystal sizes. Their small size makes photonic crystals more suitable for on-chip integration and eliminates some of the controls required by a grating (e.g. phase control). Photonic crystals also require special mathematical treatment to take account of their finite size and high refractive index contrast, since these characteristics preclude the use of coupled-mode theory normally applied to diffraction gratings. A distinction between diffraction gratings and photonic crystals is therefore the application of coupled mode theory to decide whether refractive index (RIN) contrast can be viewed as a small “perturbation” or not See C. M. de Sterke, D. G. Salinas, and J. E. Sipe, “Coupled-mode theory for light propagation through deep nonlinear gratings”, Phys. Rev. E 54, pp. 1969-1989 (1996).

Single-frequency semiconductor diode lasers are essential components in modem optical-fibre communication systems as they facilitate the high data rates necessary for point-to-point optical communication systems. There have been several suggested methods for the realisation of these sources, specifically distributed feedback (DFB) lasers, external cavity lasers and coupled-cavity lasers.

Currently DFB lasers, in which relative gain differences between different modes in the cavity are introduced by forming discontinuities within the cavity, are the sources of choice and are widely deployed in existing transmission systems. However, the wavelength of these lasers can only be tuned over a limited range by variations in temperature or current. In future optical communication systems, sources whose wavelength is tuneable over a large number of discrete wavelengths will be required, thereby requiring different device architectures to be explored.

Tuneable external cavity lasers have produced viable commercial products by the inclusion of a movable surface-relief grating in the external cavity with the grating providing the role of a frequency-selective surface. However, these devices are not suitable for future integrated optical circuits due to the need for a movable frequency-selective surface.

Coupled-cavity lasers offer the potential for frequency-stabilised and tuneable outputs that are capable of the high-data rates required for optical communication systems. These lasers have been extensively researched in the 1980s. For example, see L. A. Coldren et al, IEEE Journal of Quantum Electronics, QE-20, 659-682 (1984), and Agrawal, “Long wavelength semiconductor lasers”, Chapter 8 for a review. These results have shown that the intracavity coupling is extremely important for providing either stable single-frequency operation over a range of operating conditions (see J. E. Bowers et al, Applied Physics Letters 44 (9), 821-823 (1984)) or for providing a tuneable source. U.S. Pat. No. 4,284,963 describes an etalon laser diode and describes the cleaved coupled-cavity laser structure.

The intracavity coupling has been provided by a gap in the guiding region and reported methods are cleaved coupled-cavity lasers where two identical but physically distinct lasers are brought into close proximity or coupled-cavity lasers with a single etched gap (L. A. Coldren et al, IEEE Journal of Quantum Electronics, QE-18 (10), 1679-1687, (1984)).

However, the problem is that in order to produce stable devices, small cavity lengths (<100 μm) are required. For these cavity lengths, the mirror loss dominates (maximum reflected intensity ˜30-35%). This problem can be solved by the use of several high index-contrast layers, namely a photonic bandgap structure that provides higher and controllable values of reflected intensity. Methods of forming photonic crystal mirrors as the back mirror and output mirror in a short cavity laser have already been proposed, for example in T D Happ et al. The reflectivity of the photonic crystal is determined according to the number of periodic variations.

More recently, and for a different purpose, multi-section lasers have been used for the generation of ultrafast harmonic mode-locked lasers where the single etched gap has been replaced by photonic bandgap reflectors (D. A. Yanson et al, IEEE Journal of Quantum Electronics, 38 (1), 1-11, (2002)). Photonic bandgap structures have also been used for the production of short-cavity laser sources already (eg. T. Baba et al, Japanese Journal of Applied Physics 1, 35 (2B), 1390-1394 (1996)).

Coupled-cavity waveguides that are defined by photonic crystals themselves are known in RF and microwave design where they are considered as one entity rather than a group of separate cavities. The purpose of these coupled cavities is to engineer the dispersion properties of the waveguide, e.g. to provide slow-wave structures. These principles have also been applied to photonic crystals and consist in the photonic crystal providing the confinement, where the cavities are formed within a crystal tile (usually by creating a chain of discontinuities along which light propagates)—e.g. see A. Yariv et al., Optics Letters, 24(11), 711-713 (1999). Such waveguides cannot provide any optical gain due to the small (˜ few cubic λ/2n units) injection volume, where λ is the optical wavelength in air, and n is the refractive index of the host material.

U.S. Pat. No. 4,896,325 describes a multi-section tuneable laser with differing multi-element mirrors where these mirrors include a plurality of discontinuities to cause narrow, spaced reflective maxima. These periodic mirrors define the laser cavity and have different spectral responses to allow widely tuneable sources to be realised. In this instance the mirrors are providing a frequency-selective function. This patent also mentions coupled-cavity lasers although it proposes a different (slightly more complicated) design for tuneable lasers.

Photonic bandgap structures were first proposed by Eli Yablonovitch (Physical Review Letters, 58, 2059-2062, (1987)) for control of spontaneous emission in solid-state physics. U.S. Pat. No. 5,172,267 describes a method for making a three-dimensional photonic bandgap structure and mentions the formation of an optical cavity with such a periodic mirror.

U.S. Pat. No. 5,365,541 describes an array of parallel laser diodes which are coupled, at a back end of the cavities, by a photonic bandgap mirror that reflects in-phase modes back to the laser cavities and transmits out of phase modes. Thus, only in-phase modes of all diodes in the array will acquire sufficient gain to support lasing, and high intensity, single mode far field distribution.

U.S. Pat. No. 5,684,817 describes a laser cavity having photonic bandgap material used as the lateral and end walls of the lasing cavity thereby providing lateral (transverse) as well as longitudinal optical confinement.

U.S. Pat. No. 5,682,401 describes a DFB microcavity laser which includes an axially periodic dielectric waveguide with a local discontinuity within the periodic dielectric waveguide which discontinuity results in strong spatial confinement around the defect to generate a single mode.

Also, in the literature there have been reports of photonic bandgap structures used as laser mirrors, e.g. T. Baba et al, Japanese Journal of Applied Physics 1, 35 (2B), 1390-1394 (1996); Y. Yuan et al., IEEE Photonics Technology Letters, 9(7), 881-883 (1997); J. O'Brien et al., Electronics Letters, 32 (24), 2243-2244 (1996); T. F. Krauss et al, Optical Engineering, 37 (4), 1143-1148 (1998); L. Raffaele et al, IEEE Photonics Technology Letters, 13(3), 176-178 (2001). These references report short-cavity lasers with periodic mirrors and the means to fabricate them.

More recently, A. B. Massara et al, Electronics Letters, 36 (2), 141-142 (2001)) have reported the use of a photonic bandgap structure placed over a short length on either side of a laser waveguide to create a single contact, mode-hop-free, single longitudinal mode laser.

The present invention is directed toward the use of photonic bandgap structures (photonic crystal mirrors) in conjunction with two or more laser cavities to provide novel and advantageous structures.

More particularly, the present invention is directed toward producing continuous wave semiconductor lasers having multi- or single longitudinal mode operation using monolithically integrated, coupled-cavities whose output wavelength is tuneable, in which the cavities are coupled using photonic bandgap materials. The resonator mirrors for the cavities are formed by photonic band structures.

These lasers so formed are particularly useful for deployment in optical data transmission systems.

It is important to make a distinction between the coupling of cavities using photonic bandgap materials as discussed herein and coupled cavity waveguides defined by photonic crystals themselves as mentioned earlier. The invention differs from these in that while light confinement in the vertical dimension may be common to both, in the lateral dimension the waveguide is not defined by the photonic crystal. In this application, the purpose of the photonic bandgap is to couple cavities together, not define them.

According to one aspect, the present invention provides a monolithically integrated optical device comprising:
a first optical cavity having a first optical axis and supporting first optical modes;
a second optical cavity having a second optical axis and second, different, optical modes than the first optical cavity;
the first and second optical cavities being laterally offset from one another and at least partially separated by a photonic crystal material in which the dielectric function of the material exhibits a periodic variation as a function of linear distance through the material, such that optical coupling between the first and second cavities is achieved through the photonic crystal.

According to another aspect, the present invention provides a monolithically integrated optical device comprising:
a first optical cavity having a first optical axis and supporting first optical modes;
a second optical cavity having a second optical axis and second, different, optical modes than the first optical cavity;
the first and second optical cavities being at least partially separated from each other by a photonic crystal material such that optical coupling between the first and second cavities is achieved through the photonic crystal material; and
the photonic crystal material being formed in a quantum well intermixed region of the substrate in which the device is formed, the dielectric function of the photonic crystal material exhibiting a periodic variation as a function of linear distance through the material.

Embodiments of the present invention will now be described by way of example and with reference to the accompanying drawings, in which:

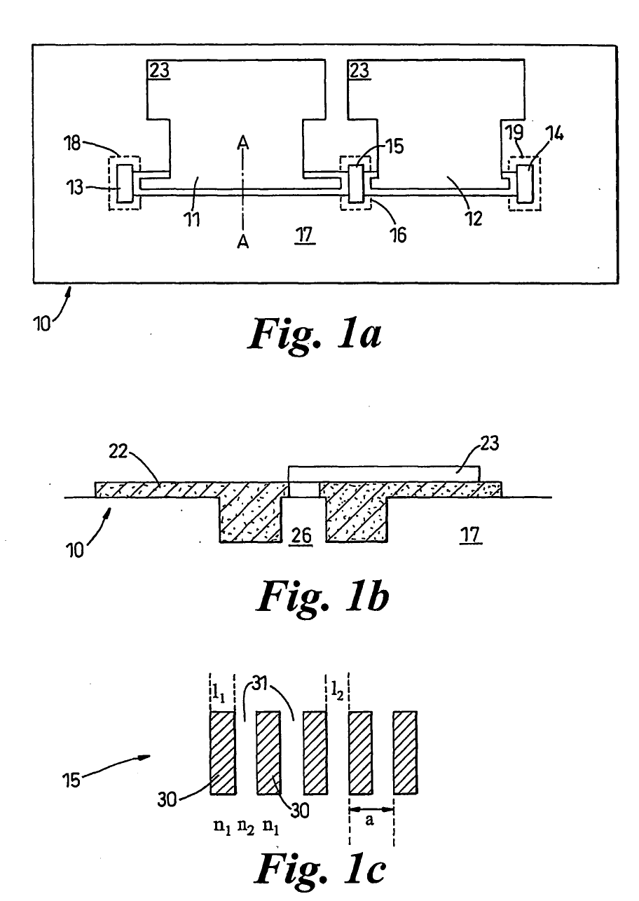

FIG. 1a is a schematic plan view diagram of a coupled cavity laser device having cavities coupled by photonic crystal material formed in quantum well intermixed regions of the substrate;

FIG. 1b is a cross-sectional view of the device of FIG. 1, on line A-A;

FIG. 1c is a schematic plan view of photonic crystal material used in the device of FIG. 1a, exhibiting periodicity in one dimension;

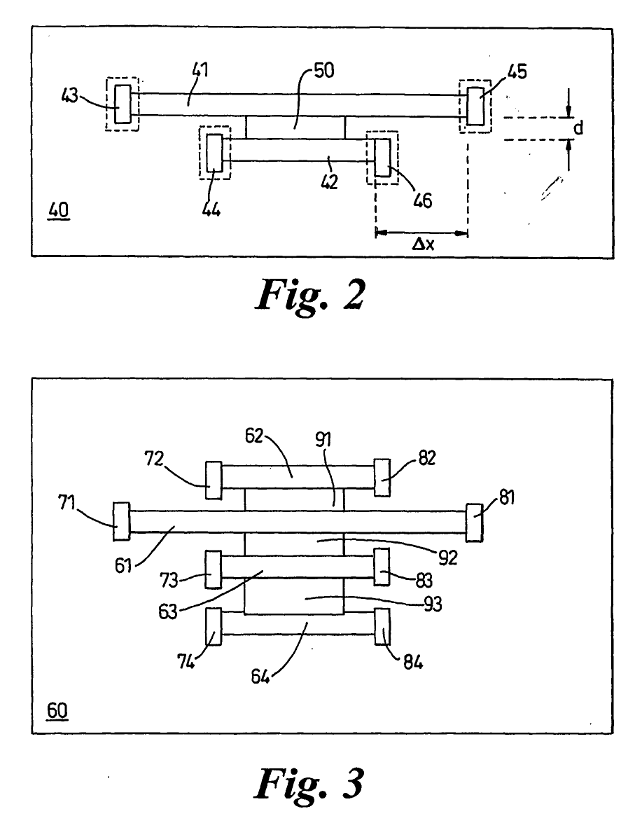

FIG. 2 is a schematic plan view of a two-section laser having parallel, different length cavities laterally separated from one another by a photonic crystal material;

FIG. 3 is a schematic plan view of a multi-section laser having plural parallel cavities having varying lengths laterally separated from one another by a photonic crystal material;

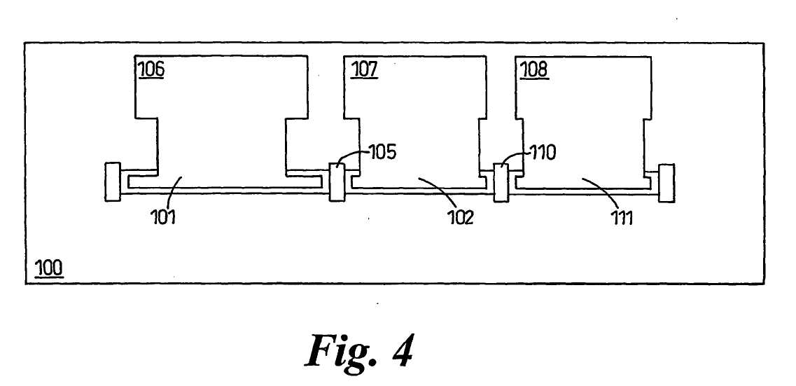

FIG. 4 is a schematic plan view of a multi-section optical device incorporating laser cavity, optical amplifier and a modulator elements having a common optical axis and separated by photonic crystal material;

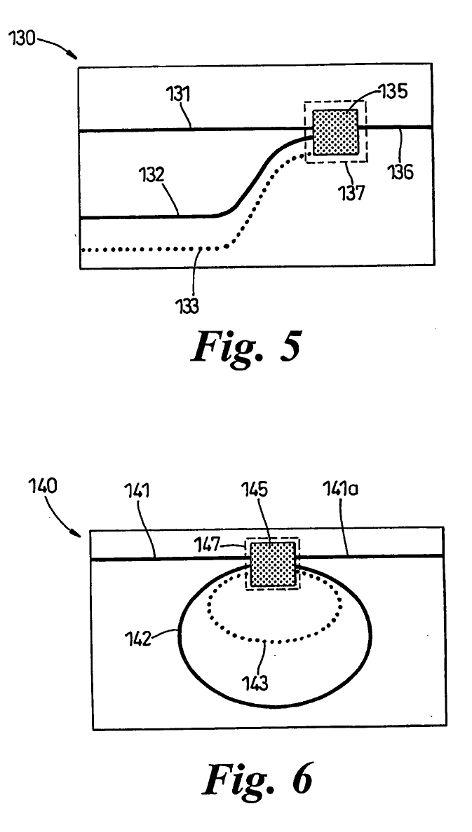

FIG. 5 is a schematic plan view of a multi-cavity optical device having plural convergent cavities coupled by photonic crystal material; and

FIG. 6 is a schematic plan view of a multi-cavity optical device having plural cavities, including a ring cavity, the cavities being coupled by a photonic crystal material.

A number of monolithically integrated, multi-cavity optical devices are now described that each include at least two cavities which are coupled using photonic crystal material. Throughout the present specification, the expression “cavity” is intended to encompass the electrically and optically active portion of a waveguiding structure to which electrical bias may be applied to modulate the optical gain of the structure.

With reference to FIG. 1a, an optical device 10 incorporates a first waveguide cavity 11 and a second waveguide cavity 12 having a common optical axis. Each waveguide cavity 11, 12 is preferably of a different length. Thus, each cavity supports different optical modes. In combination, the two waveguide cavities 11, 12 co-operate to facilitate modification of the spectral properties of the optical device over those of the separate waveguide cavities, using known techniques. In other words, the optical coupling of the cavities is effected to provide tuneability of the optical device.

At each end of the coupled cavity, first and second end mirrors 13, 14 are provided. Preferably, a first one of these end mirrors 13 has a very high reflection coefficient to reflect substantially all of the radiation back into the first cavity 11. Preferably, the second end mirror 14 has a low reflection coefficient, being used as an output facet of the optical device. An anti-reflection coating may be provided.

The waveguide cavities 11, 12 are optically coupled by a photonic crystal material 15 in which the dielectric function of the material exhibits a periodic variation as a function of linear distance along the optical axis of the optical device. In this manner, optical coupling between the first and second cavities 11, 12 is achieved through the photonic crystal material 15.

To avoid catastrophic optical damage occurring within the photonic crystal material 15, the photonic crystal material is formed within a region 16 of the substrate 17 having an altered electronic bandgap to form an optically passive, non-absorbing portion of the waveguide. The bandgap is preferably altered by the use of quantum well intermixing techniques in which atoms within the quantum well of the waveguide are exchanged with atoms from an adjacent barrier material to modify the semiconductor bandgap.

Various possible methods of quantum well intermixing (QWI) may be used to achieve the desired effect, such as impurity-based QWI, implantation-induced QWI, laser induced QWI, and impurity free vacancy disordering, which techniques are generally described in the art.

Preferably, the end mirrors 13, 14 are also formed within respective regions 18, 19 of altered electronic bandgap to form another optically passive, non-absorbing portion of the waveguide. Thus, catastrophic optical damage to the end mirrors is also avoided.

With reference to FIG. 1b, the optical device 10 is shown in cross-section on line A-A to illustrate a preferred waveguide and contact structure. Preferably, the optical device is formed using a conventional layered semiconductor laser diode structure, consisting of several semiconductor layers (not shown) of predetermined electronic bandgap, refractive index, thickness and doping, the waveguide being formed by etching a ridge 26 therein. In a preferred embodiment, the ridge has a height and a width between approximately 0.5 and 4 microns, and provides the requisite optical confinement and electrical injection current confinement.

The exact geometry of the waveguide 26 is preferably chosen to ensure a single transverse optical mode and is dependent on the particular details of the heterostructure used. The lateral walls of the waveguide may be bounded by a deposited layer 22 of dielectric or low-k material (where k is the electrostatic constant) according to known techniques.

A p-type contact 23 is deposited on top of the ridge waveguide 26 to provide current injection into the device.

In a preferred embodiment, the waveguide 26 is formed for both cavities 11, 12 simultaneously, in a substrate structure in which the quantum well intermixed regions 16, 18 and 19 have already been formed using conventional intermixing processes.

The multiple cavities of the optical device 10 are then formed by etching one- or two-dimensional photonic bandgap structures 15 in the passive region 16. The periodicity of the photonic bandgap structure 15 preferably lies parallel to, and/or orthogonal to, the waveguide (cavity) axis.

FIG. 1c illustrates a schematic diagram of a photonic bandgap (photonic crystal) structure 15 having periodic layers 30, 31, each of thickness l₁, l₂ respectively, having differing refractive index, n₁ and n₂ respectively. The periodicity of the photonic crystal, a, is the thickness of two adjacent layers 30, 31, l₁+l₂. The fill factor is the geometric percentile area occupied by the low refractive index material compared to the total area in the unit cell. For one dimensional photonic crystal material, as shown, this is the ratio of the thicknesses of the two successive layers, expressed as l₂/(l₁+l₂). These alternating layers of relatively high and relatively low refractive index produce, through interference, a wavelength-dependent reflection and transmission.

In the preferred embodiments, the photonic crystal is formed by etching out regions of the semiconductor substrate, such that the regions of relatively high refractive index n₁ comprise semiconductor material and the regions of relatively low refractive index n₂ comprise air. The use of a semiconductor-air photonic crystal structure yields a large reflection bandwidth that has a normalised frequency range Δu˜0.2, where u is the normalised frequency and is equal to the period, a, divided by the free-space wavelength, λ₀.

The period of the photonic bandgap structures is preferably between 0.3 λ and 3 λ, where λ is the wavelength of light in the material, i.e. λ=λ₀/n (λ₀ is the wavelength in air and n is the optical refractive index). The fill-factor is preferably between 20% and 80%, although a typical value in the range 30-40%.

The photonic bandgap structures are preferably lithographically defined using techniques such as electron-beam lithography, although other techniques may be used. The photonic crystal is first defined using lithography to remove material from the electron-sensitive material leaving a periodic arrangement of this material and air. The pattern may then be transferred into intermediate materials of varying thickness before eventually being etched into the heterostructure waveguide using dry-etching techniques, e.g. reactive-ion etching. The etch depth is between 0.5λ and 5λ from the semiconductor-air interface although the preferred depth would be 3λ-5λ. Fabrication techniques for forming photonic bandgap structures are well described in the art, for example J. R Wendt et al., J. Vacuum Science and Technology B, 11, 2637-2640 (1993); T. Krauss et al., Electronics Letters, 30, 1444-1446 (1994); J. M. Gerard et al., Solid-state Electronics, 37, 1341-1344 (1994).

Preferably, QWI processing is carried out prior to the formation of any photonic crystal material. If etching of the photonic crystal material is performed prior to QWI processing, then some advantages of QWI may not be present, e.g. one could obtain a unobvious intermixing effect from a patterned surface. At its most simple a non-uniform intermixing effect would most likely result.

The use of lithographic methods to define the cavity lengths allows for the optimum ratio to be defined. The impact of ratio has already been examined in the literature (e.g. J. E. Bowers et al., Applied Physics Letters 44 (9), 821-823 (1984)), but the use of lithograph) advantageously allows arbitrarily short laser cavities to be used. With very short cavity lengths, higher reflectivities are required. Photonic crystal material can provide reflection coefficients of between 0 and 100% and can thus exactly match cavity length to reflectivity.

The use of quantum well intermixing allows for alteration of the electronic bandgap in the region of the photonic crystal material, thereby localising the optical gain to the desired cavity areas and protecting the photonic crystal material from catastrophic optical damage. The ability to perform the photonic crystal bandgap engineering using lithography and surface processing techniques makes the ease of integration of these processes with quantum well intermixing easier.

The use of photonic crystal structures as a coupling medium 15 between two or more cavities generally provides a highly controllable reflection coefficient across a wide frequency range, particularly required for short-cavity lasers and therefore particularly advantageous for stable single-frequency lasers. The photonic crystal structures allow very short cavities of less than 20 microns to be formed thereby allowing very stable operation and good spurious mode suppression.

The photonic crystal structures also exhibit a relatively flat reflection amplitude and phase variation across a significant fraction of the photonic bandgap and as such simplify the control of coupled cavity optical devices.

The two-dimensional waveguiding properties of the optical waveguide are maintained in the intracavity material and radiation loss by out-of-plane diffraction is minimised over that which is achieved using a single gap coupling medium.

Because the photonic crystal bandgap structures can be lithographically defined, they allow for arbitrarily small cavity lengths and a high degree of control of the optical cavity dimensions.

The cavity-coupling photonic crystal material structures produce a broad stop-band. Tuning and/or stabilisation may be achieved through carrier injection in one of the coupled cavities. A significant difference between the present photonic crystal couplers described herein compared with cleaved-coupled cavity lasers is that precise control of the cavity lengths and the coupling between them is achieved by lithographic control.

The use of cavity-coupling photonic crystal material may also eliminate the need for a phase control section. When photonic crystal material acts as mirrors, the key factor that controls the modal spacing (standing wave pattern) is the cavity length—C. J. M. Smith et al., IEE Proceedings J. Optoelectronics, 145, 373-378 (1998).

The formation of the photonic crystal material 15 in quantum well intermixed regions 16 allows the mirrors to be non-absorbing across a large frequency range and reduces current injection into the photonic crystal material. This prevents heating and device degradation.

The formation of the photonic crystal material 15 in quantum well intermixed regions 16 can be effective in reducing: catastrophic optical damage; cavity losses; carrier-induced index variation; and non-radiative recombination at etched sidewalls of the photonic crystal material.

Although the optical device of FIG. 1a is shown to include two cavities coupled by way of a photonic crystal material cavity coupler, the principle described extends to the coupling of more than two cavities in series by way of two or more cavity couplers.

More generally, as will now be illustrated, it has been determined that the optical cavities coupled by way of the photonic crystal materials do not need to be co-axial, and coupling between parallel and non-parallel adjacent cavities can also be achieved, using similar precision photolithographic techniques to define the periodic structure.

With reference to FIG. 2, an optical device 40 comprises a first optical cavity 41 of first length that supports first optical modes, and a second optical cavity 42, parallel to the first optical cavity and of second length that supports second optical modes. Each cavity has first and second end mirrors, respectively labelled 43, 44, 45 and 46. In a preferred embodiment, at least three of these end mirrors have a high reflection coefficient, while one mirror provides for optical output from the optical device. Preferably, the output mirror is one of the end mirrors 43, 45 of the longer cavity.

Optical coupling between the two cavities 41, 42 is effected by forming an optical coupler in a photonic crystal material 50, which coupler at least partially separates the cavities. In one arrangement, the photonic crystal material 50 defines an optical coupling medium in which the dielectric function of the material exhibits a periodic variation in a direction orthogonal to the axes of the first and second cavities 41, 42. In another arrangement, the photonic crystal material 50 defines an optical coupling medium in which the dielectric function of the material exhibits a periodic variation in a direction parallel to the optical axes of the first and second cavities 41, 42. More generally, the photonic crystal material optically coupling the first and second cavities may have periodicity in its dielectric function in one or more dimensions, orthogonal, transverse or parallel to the optical axes of the first and second cavities such that optical coupling between the first and second cavities is achieved through the photonic crystal material.

This particular configuration of optical device also enables the second cavity to have relative longitudinal displacement to the first cavity, by the distance indicated at Δx. The relative longitudinal displacement Δx may be zero, in which case the respective end mirrors 45, 46 are co-planar. The end mirrors may themselves be formed in the photonic crystal material. For an arrangement in which Δx is zero, a common end mirror may be used.

The lateral separation d of the two cavities, the relative lengths of the two cavities, the relative longitudinal displacement Δx of the two cavities, the physical dimensions and attributes of the photonic crystal material used as the optical coupler, may all be suitably varied in order to achieve the desired spectral output of the optical device.

Preferably, the photonic crystal material 50 is formed in a quantum well intermixed region (as discussed above) to alter the electronic bandgap in the region of the photonic crystal material, thereby localising the optical gain to the desired cavity areas and protecting the photonic crystal material from catastrophic optical damage.

With reference to FIG. 3, an optical device 60 comprises a first optical cavity 61 of first length that supports first optical modes, and a plurality of secondary optical cavities 62, 63 and 64, parallel to the first optical cavity and of varying lengths that support further optical modes. Each cavity 61-64 has first and second end mirrors, respectively labelled 71-74 and 81-84. In a preferred embodiment, all but one end mirror 81 in the first optical cavity have a very high reflection coefficient, while the one end mirror 81 provides for optical output from the optical device.

Optical coupling between the plural cavities 61-64 is effected by forming optical cavity couplers 91-93 in a photonic crystal material between each of the adjacent cavities, to laterally separate the cavities.

In one arrangement, the photonic crystal material of the optical cavity couplers 91-93 defines an optical coupling medium in which the dielectric function of the material exhibits a periodic variation in a direction orthogonal to the axes of the cavities 61-64. In another arrangement, the photonic crystal material of the optical cavity couplers 91-93 defines an optical coupling medium in which the dielectric function of the material exhibits a periodic variation in a direction parallel to the optical axes of the first and second cavities 61-64. More generally, the photonic crystal material optically coupling laterally adjacent cavities may have periodicity in its dielectric function in one or more dimensions, orthogonal, transverse or parallel to the optical axes of the adjacent cavities such that optical coupling between the adjacent cavities is achieved through the photonic crystal material.

This particular configuration of optical device also enables plural adjacent coupled cavities to have differing lengths and differing relative longitudinal displacements. This allows very complex spectral engineering of optical output of the device as a whole.

The number of cavities, their relative lateral separations dₙ, their relative lengths, their relative longitudinal displacements Δx, the physical dimensions and attributes of the photonic crystal material used in the optical couplers between the cavities may all be suitably varied in order to achieve the desired spectral output of the optical device.

Any or all of the photonic crystal optical cavity couplers 91-93 and end mirrors 71-74, 81-84 may be formed in quantum well intermixed regions (as discussed above) to alter the electronic bandgap in the region of the photonic crystal material, thereby localising the optical gain to the desired cavity areas and protecting the photonic crystal material from catastrophic optical damage.

With reference to FIG. 4, an optical device 100 may incorporate not only at least two coaxial optical cavities 101, 102 coupled by way of a photonic crystal material 105 (compare with the example of FIG. 1a), but may also include an optical amplifier, modulator cavity or intermixed waveguide 111 also coupled to the first and second cavities 101, 102 by way of a photonic crystal material coupler 110. Thus, in general, one of the coupled optical cavities may comprise an amplifier to boost the output power of the optical device, or may comprise a modulator to modify the output power of the optical device, or may comprise a waveguide with an altered bandgap to guide light between cavities. Each of the active elements of the optical device is provided with separate electrical contacts, respectively labelled 106, 107, 108.

Furthermore, if the optical device forms part of an optical transmission system, the photonic crystal material coupler may be designed to have a passband matching the bandwidth of the transmitted signal, thus filtering out any unwanted amplifier noise outside the bandwidth.

Preferably, the photonic crystal material of the optical coupler 110 is formed in a quantum well intermixed region (as discussed above) to alter the electronic bandgap in the region of the photonic crystal material, thereby localising the optical gain to the desired cavil areas and protecting the photonic crystal material from catastrophic optical damage.

More generally, the coupled cavities need not have optical axes that are co-axial or parallel. The cavities coupled by the photonic crystal couplers may be laterally adjacent but non-parallel to one another. Still further, the optical axis of a cavity need not be linear, but may be curved.

With reference to FIG. 5, an optical device 130 comprises a first optical cavity 131 of a first length that supports first optical modes, and a second optical cavity 132, of a second length that supports second optical modes. The second cavity 132 branches into the first cavity 131 at an optical cavity coupler 135 formed in a photonic crystal material which acts as a first end mirror to both cavities, The first and second optical cavities 131, 132 each have a second end mirror, or coupling to another cavity at an opposite end thereof (not shown). A third optical cavity, or output waveguide 136 may be coupled to the other side of the photonic crystal material optical coupler 135.

Generally speaking, the photonic crystal material provides an optical coupling between two or more convergent cavities, and may also provide coupling into an input or output waveguide.

In one arrangement, the photonic crystal material used in the optical cavity coupler 135 defines an optical coupling medium in which the dielectric function of the material exhibits a periodic variation in a direction parallel to the axis of the first cavities 131. In another arrangement, the photonic crystal material defines an optical coupling medium in which the dielectric function of the material exhibits a periodic variation in a direction orthogonal to the optical axis of the first cavity 131.

More generally, the photonic crystal material optically coupling the first and second cavities may have periodicity in its dielectric function in one or more dimensions, orthogonal, transverse or parallel to the optical axes of the first and second cavities such that optical coupling between the first and second cavities is achieved through the photonic crystal material.

The lateral separation d of the two cavities, the relative lengths of the two cavities, the physical dimensions and attributes of the photonic crystal material used as the optical coupler, may all be suitably varied in order to achieve the desired spectral output of the optical device.

Preferably, the photonic crystal material of the optical coupler 135 is formed in a quantum well intermixed region 137 (as discussed above) to alter the electronic bandgap in the region of the photonic crystal material, thereby localising the optical gain to the desired cavity areas and protecting the photonic crystal material from catastrophic optical damage.

As indicated by the dotted line, further cavities 133 may be provided also convergent upon, and coupled by, the optical cavity coupler 135.

With reference to FIG. 6, an optical device 140 comprises a first optical cavity 141 of a first length that supports first optical modes, and a second optical cavity 142, of a second length that supports second optical modes. The second cavity 142 is a ring cavity and branches into and out of the first cavity 141 at an optical cavity coupler 145 formed in a photonic crystal material. The first optical cavity 141 may effectively comprise two sub-cavities 141 and 141a, on other side of the coupler 145, or may be a single cavity adjacent the coupler 145. In another arrangement, the portion 141a may be an output waveguide, ie. a passive structure not forming part of the optical cavity 141.

Generally speaking, again the photonic crystal material provides an optical coupling between two or more convergent cavities 141, 142, and may also provide coupling into an input or output waveguide.

In one arrangement, the photonic crystal material used in the optical cavity coupler 145 defines an optical coupling medium in which the dielectric function of the material exhibits a periodic variation in a direction parallel to the axis of the first cavity 141. In another arrangement, the photonic crystal material defines an optical coupling medium in which the dielectric function of the material exhibits a periodic variation in a direction orthogonal to the optical axis of the first cavity 141.

More generally, the photonic crystal material optically coupling the first and second cavities may have periodicity in its dielectric function in one or more dimensions, orthogonal, transverse or parallel to the optical axes of the first and second cavities such that optical coupling between the first and second cavities is achieved through the photonic crystal material.

The relative lengths of the two cavities, the physical dimensions and attributes of the photonic crystal material used as the optical coupler, may all be suitably varied in order to achieve the desired spectral output of the optical device.

Preferably, the photonic crystal material of the optical coupler 145 is formed in a quantum well intermixed region 147 (as discussed above) to alter the electronic bandgap in the region of the photonic crystal material, thereby localising the optical gain to the desired cavity areas and protecting the photonic crystal material from catastrophic optical damage.

As indicated by the dotted line, further ring cavities 143 may be provided also convergent upon, and coupled by, the optical cavity coupler 145.

More generally, as shown in FIGS. 5 and 6, at least one of the cavities coupled by the couplers 135, 145 is non-linear, which expression is to include any bent, curved or ring configuration of cavity.

In a further arrangement, any one of the optical devices described in connection with FIGS. 1 to 6 may be provided with an additional electrical drive terminal associated with one or more of the cavities to alter the refractive index of the cavity medium through the electro-optic effect. This enables the control of, and shift in, the output wavelength of the coupled-cavity optical device.

In a further arrangement, one or more of the cavities may be provided with a saturable absorber to produce a mode-locked laser, in which a quantum well intermixed region widens the gain spectrum such that in conjunction with the photonic crystal material couplers, ultra-short pulse lasers can be realised.

Other embodiments are intentionally within the scope of the accompanying claims.

1. A monolithically integrated optical device comprising:
a first optical cavity having a first optical axis and supporting first optical modes;
a second optical cavity having a second optical axis and second, different, optical modes than the first optical cavity;
the first and second optical cavities being laterally offset from one another and at least partially separated by a photonic crystal material in which the dielectric function of the material exhibits a periodic variation as a function of linear distance through the material, such that optical coupling between the first and second cavities is achieved through the photonic crystal.

2. The optical device of claim 1 in which the first and second optical axes are parallel.

3. The optical device of claim 1 in which the first and second optical axes are non-parallel.

4. The optical device of claim 1 in which the first and second optical cavities are of different lengths.

5. The optical device of claim 4 in which one of the cavity end mirrors of the first optical cavity is co-planar with a corresponding one of the cavity end mirrors of the second optical cavity.

6. The optical device of claim 5 in which the photonic crystal material forms the corresponding cavity end mirrors of the first and second optical cavities.

7. The optical device of claim 4 in which neither of the cavity end mirrors of the first optical cavity is co-planar with either cavity end mirror of the second optical cavity.

8. The optical device of claim 1 in which the first and second optical cavities are separated by the photonic crystal material along lateral edges thereof.

9. The optical device of claim 1 further including at least a third optical cavity having a third optical axis and supporting third optical modes, the optical cavity being separated from at least one of the first or second optical cavities by the same or further photonic crystal material such that optical coupling between the cavities is achieved through the same or further photonic crystal material.

10. The optical device of claim 1 in which the photonic crystal material exhibits a periodicity along an axis orthogonal to the first and/or the second optical axis.

11. The optical device of claim 1 in which the photonic crystal material exhibits a periodicity along an axis parallel to the first and/or second optical axis.

12. The optical device of claim 1 in which the photonic crystal material exhibits periodicity along two or more axes.

13. The optical device of claim 1 in which the photonic crystal material is formed in a quantum well intermixed region of a substrate of the optical device.

14. A monolithically integrated optical device comprising:
a first optical cavity having a first optical axis and supporting first optical modes;
a second optical cavity having a second optical axis and second, different, optical modes than the first optical cavity;
the first and second optical cavities being at least partially separated from each other by photonic crystal material such that optical coupling between the first and second cavities is achieved through the photonic crystal material; and
the photonic crystal material being formed in a quantum well intermixed region of the substrate in which the device is formed, the dielectric function of the photonic crystal material exhibiting a periodic variation as a function of linear distance through the material.

15. The optical device of claim 14 in which the first and second optical axes are coaxial, the photonic crystal material forming a passive optical coupling medium between the first and second optical cavities.

16. The optical device of claim 14 in which the first and second optical axes are parallel.

17. The optical device of claim 14 in which the first and second optical axes are non-parallel.

18. The optical device of claim 14 in which the first and second optical cavities are of different lengths.

19. The optical device of claim 18 in which one of the cavity end mirrors of the first optical cavity is co-planar with a corresponding one of the cavity end mirrors of the second optical cavity.

20. The optical device of claim 19 in which the photonic crystal material forms the corresponding cavity end mirrors of the first and second optical cavities.

21. The optical device of claim 18 in which neither of the cavity end mirrors of the first optical cavity is co-planar with either cavity end mirror of the second optical cavity.

22. The optical device of claim 14 in which the first and second optical cavities are separated by the photonic crystal material along lateral edges thereof.

23. The optical device of claim 14 further including at least a third optical cavity having a third optical axis and supporting third optical modes,
the third optical cavity being separated from at least one of the first or second optical cavities by the same or further photonic crystal material such that optical coupling between the cavities is achieved through the same or further photonic crystal material.

24. The optical device of claim 14 in which the photonic crystal material exhibits a periodicity along an axis orthogonal to the first and/or the second optical axis.

25. The optical device of claim 14 in which the photonic crystal material exhibits a periodicity along an axis parallel to the first and/or second optical axis.

26. The optical device of claim 14 in which the photonic crystal material exhibits periodicity along two or more axes.

27. The optical device of claim 1 in which at least one of the cavities is non-linear.

28. (canceled)
